(19) United States
(12) Patent Application Publication
(10) Pub. No.: US 2005/0003085 A1
(43) Pub. Date: Jan. 6, 2005

(54) Composition for forming a coating film, method of preparing the composition, tantalum oxide film and method of forming the tantalum oxide film

(75) Inventors: Isamu Yonekura, Tokyo (JP); Sachiko Hashimoto, Tokyo (JP); Hitoshi Kato, Tokyo (JP); Tatsuya Sakai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR Corporation, Tokyo (JP)

(21) Appl. No.: 10/820,056

(22) Filed: Apr. 8, 2004

(30) Foreign Application Priority Data
Apr. 9, 2003 (JP) 2003-105182
Jun. 26, 2003 (JP) 2003-182221

(51) Int. Cl. B05D 3/02

(52) U.S. Cl. 427/226; 106/287.18; 423/62

(57) ABSTRACT

A composition for forming a coating film, comprising a reaction product of a tantalum alkoxide and at least one compound selected from carbamic acid, carboxylic acid and carboxylic anhydride and a solvent. A tantalum oxide film is obtained by forming a coating film of this composition and thermally and/or optically treating the coating film. This tantalum oxide film has a large dielectric constant and a small leak current.

### FIELD OF THE INVENTION

The present invention relates to a composition for forming a coating film, a method of preparing the composition, a tantalum oxide film and a method of forming the tantalum oxide film.

More specifically, it relates to a composition for forming a tantalum oxide film suitable for use as an insulating film for semiconductor devices such as a capacitor insulating film or a gate insulating film for DRAMs, a method of preparing the composition, a tantalum oxide film and a method of forming the tantalum oxide film.

### DESCRIPTION OF THE PRIOR ART

The area of a capacitor in a DRAM (Dynamic Random Access Memory) is becoming smaller due to the higher integration and density of a semiconductor device. If the capacitance decreases along with a reduction in the area of the capacitor, the malfunctioning of a device may be caused by a software error. Therefore, even when the area of the capacitor becomes small, a sufficiently large capacitance must be secured. One of the solutions to this problem is the use of an insulating film having a large dielectric constant or a high dielectric film. SiO₂ and Si₃N₄ have been generally used in capacitor insulating films, and a sufficiently large capacitance has been secured by a 3-D memory cell structure. However, it is becoming difficult to secure a memory cell capacitance by a conventional method due to a drastic increase in the integration and a drastic reduction in the pattern width of a DRAM.

Tantalum oxide has a dielectric constant which is 3 times or more larger than those of SiO₂ and Si₃N₄ which have been used in capacitor insulating films, and a thin tantalum oxide film having excellent step coverage can be easily formed by CVD. Therefore, studies on tantalum oxide as the next-generation DRAM capacitor insulating film are under way. A method of forming an insulating film of tantalum oxide by CVD is disclosed in Applied Physics 69 (9), p. 1067 (2000). Various studies on tantalum materials used in CVD are reported in Electronic Materials, vol. 7, p. 18, 2000.

However, tantalum oxide insulating films formed by conventional CVD contain impurities and lattice defects caused by raw materials and film forming methods, which cause a leak current and deteriorate dielectric strength. Tantalum alkoxides which are used to form a film by CVD have problems that they have high hydrolyzability and that a large amount of an impurity such as carbon remains in the formed tantalum oxide film. Further, film formation by CVD requires a bulky apparatus which is expensive and consumes a huge amount of energy for vacuum and plasma systems, thereby boosting the cost of a product.

As means of forming a tantalum oxide film without requiring the above bulky apparatus, there is disclosed a method of forming a tantalum oxide film by applying a tantalum alkoxide or the like to a substrate and heating it (JP-A 59-181413) (the term “JP-A” as used herein means an “unexamined published Japanese patent application”). However, this method has a problem that the tantalum alkoxide used as a raw material cannot be kept for a long time. That is, even when it is kept in an airtight container which can be generally acquired industrially, deterioration or modification which is presumed to be caused by oxygen or water contained in the air due to slight leakage during storage is seen while it is kept. When a film is to be formed from a raw material which has been kept for a predetermined period of time, stable film formation is impossible. The material must be kept dry in an inert atmosphere, which reduces production efficiency.

### SUMMARY OF THE INVENTION

It is an object of the present invention to provide a composition for forming a coating film to form a tantalum oxide film, which solves the above problem, from which a high-quality tantalum oxide film having a sufficiently large dielectric constant and a small leak current can be formed easily and efficiently, and which can be kept at a high ambient humidity for a long time.

It is another object of the present invention to provide a method of manufacturing the above composition for forming a coating film industrially advantageously.

It is still another object of the present invention to provide a method of forming a high-quality tantalum oxide film even at a high humidity.

It is a further object of the present invention to provide a high-quality tantalum oxide film formed from the above composition.

Other objects and advantages of the present invention will become apparent from the following description.

According to the present invention, firstly, the above objects and advantages of the present invention are attained by a composition for forming a coating film, which comprises a reaction product of a tantalum alkoxide and at least one compound selected from the group consisting of carbamic acid, carboxylic acid and carboxylic anhydride, and a solvent, and is used to form a tantalum oxide film.

According to the present invention, secondly, the above objects and advantages of the present invention are attained by a method of preparing the composition for forming a coating film of the present invention, comprising the steps of:

(1) reacting a tantalum alkoxide with at least one compound selected from the group consisting of carbamic acid, carboxylic acid and carboxylic anhydride in the presence of a solvent as required; and

(2) adding a solvent to the obtained reaction product as required to prepare a composition for forming a coating film, containing the solvent.

According to the present invention, thirdly, the above objects and advantages of the present invention are attained by a method of forming a tantalum oxide film, comprising the steps of:

(1) forming a coating film of the composition for forming a coating film of the present invention on a substrate; and

(2) thermally and/or optically treating the coating film.

According to the present invention, in the fourth place, the above objects and advantages of the present invention are attained by a tantalum oxide film formed from the composition for forming a coating film of the present invention or formed by the method of the present invention.

### BRIEF DESCRIPTION OF THE DRAWINGS

FIG. 1 is a ¹H NMR chart of a product obtained in Synthesis Example 1;

FIG. 2 is a ¹H NMR chart of a product obtained in Synthesis Example 2; and

FIG. 3 is a ¹H NMR chart of a product obtained in Synthesis Example 3.

### DETAILED DESCRIPTION OF THE PREFERRED EMBODIMENT

Each component of the composition for forming a coating film of the present invention will be described in detail hereinunder.

Tantalum Alkoxide

The tantalum alkoxide used in the present invention is preferably a compound represented by the following formula (1):
Ta(OR¹)ₛ (1)
wherein R¹ is an alkyl group having 1 to 6 carbon atoms, with the proviso that five R¹'s may be the same or different.

Examples of the tantalum alkoxide include tantalum pentamethoxide, tantalum pentaethoxide, tantalum pentaisopropoxide and tantalum pentabutoxide. Out of these, tantalum pentaethoxide, tantalum pentaisopropoxide and tantalum pentabutoxide are preferred.

These tantalum alkoxides may be used alone or in combination of two or more.

One Compound Selected From Carbamic Acid, Carboxylic Acid and Carboxylic Anhydride

At least one compound selected from carbamic acid, carboxylic acid and carboxylic anhydride used in the present invention is carbamic acid, a monocarboxylic acid having one carboxyl group in the molecule, a polycarboxylic acid having two or more carboxyl groups in the molecule or a polycarboxylic anhydride having two or more carboxyl groups in the molecule.

The carboxylic acid is a monocarboxylic acid represented by the following formula (2): 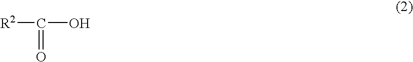
wherein R² is an alkyl group having 1 to 6 carbon atoms or haloalkyl group having 1 to 6 carbon atoms,
or a dicarboxylic acid represented by the following formula (3):
HOOC—R³—COOH (3)
wherein R³ is a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms.

The carboxylic anhydride is a monocarboxylic anhydride represented by the following formula (4): 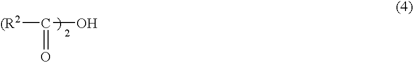
wherein R² is as defined in the above formula (2), or a dicarboxylic anhydride represented by the following formula (5): 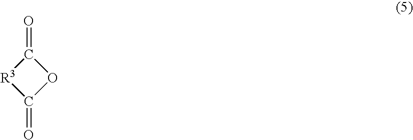
wherein R³ is as defined in the above formula (3).

Examples of the monocarboxylic acid having one carboxyl group in the molecule include acetic acid, propionic acid, butyric acid, valeric acid, trifluoroacetic acid, difluoroacetic acid, monofluoroacetic acid, trichloroacetic acid, dichloroacetic acid, monochloroacetic acid, tribromoacetic acid, dibromoacetic acid, monobromoacetic acid, glycine, alanine and leucine.

Examples of the polycarboxylic acid having two or more carboxyl groups in the molecule include oxalic acid, malonic acid, methylmalonic acid, succinic acid, glutaric acid, adipic acid, polyacrylic acid, polymethacrylic acid, itaconic acid, maleic acid, fumaric acid, citraconic acid, mesaconic acid and citric acid.

Examples of the polycarboxylic anhydride having two or more carboxyl groups in the molecule include maleic anhydride, citraconic anhydride, malonic anhydride, itaconic anhydride and succinic anhydride.

Out of these, monocarboxylic acids having one carboxyl group in the molecule and polycarboxylic anhydrides having two or more carboxyl groups in the molecule are preferred, and acetic acid, trifluoroacetic acid, trichloroacetic acid, tribromoacetic acid, meleic acid, citraconic acid, maleic anhydride and citraconic anhydride are particularly preferred.

They may be used alone or in admixture of two or more.

Reaction Product of a Tantalum Alkoxide and at Least One Compound Selected From Carbamic Acid, Carboxylic Acid and Carboxylic Anhydride

The reaction product of a tantalum alkoxide and at least one compound selected from carbamic acid, carboxylic acid and carboxylic anhydride can be obtained from a reaction between the above tantalum alkoxide and at least one compound selected from carbamic acid, carboxylic acid and carboxylic anhydride.

The above reaction may be carried out by using at least one compound selected from carbamic acid, carboxylic acid and carboxylic anhydride in an amount of preferably 0.1 to 100 mols, more preferably 0.5 to 50 mols, particularly preferably 1 to 5 mols based on 1 mol of the tantalum alkoxide.

The reaction temperature is preferably −30 to 150° C., more preferably 0 to 100° C., particularly preferably 0 to 70° C. The reaction time is preferably 30 minutes to 48 hours, more preferably 1 to 24 hours, particularly preferably 3 to 12 hours.

The reaction pressure may be normal pressure but the reaction may be carried out under increased pressure or reduced pressure as required.

The above reaction can be carried out in the presence of a suitable solvent as required.

When a solvent is used in the above reaction, a solvent which does not react with the tantalum alkoxide, at least one compound selected from carbamic acid, carboxylic acid and carboxylic anhydride, and the reaction product of them is preferably used.

The solvent is, for example, a hydrocarbon-based solvent, ether-based solvent, ester-based solvent or other polar solvent. Examples of the hydrocarbon-based solvent include n-pentane, cyclopentane, n-hexane, cyclohexane, n-heptane, cycloheptane, n-octane, cyclooctane, decane, cyclodecane, dicyclopentadiene hydride, benzene, toluene, xylene, durene, indene, tetrahydronaphthalene, decahydronaphthalene and squalane.

Examples of the ether-based solvent include diethyl ether, dipropyl ether, dibutyl ether, ethylene glycol dimethyl ether, ethylene glycol diethyl ether, ethylene glycol methyl ethyl ether, diethylene glycol diethyl ether, diethylene glycol methyl ethyl ether, tetrahydrofuran, tetrahydropyran, bis(2-methoxyethyl)ether and p-dioxane.

Examples of the ester-based solvent include ethylene glycol monomethyl ether acetate, ethylene glycol monoethyl ether acetate, propylene glycol monomethyl ether acetate, propylene glycol monoethyl ether acetate, methyl lactate and ethyl lactate.

Examples of the other polar solvent include propylene carbonate, γ-butyrolactone, N-methyl-2-pyrrolidone, dimethyl formamide, acetonitrile, dimethyl sulfoxide, methylene chloride and chloroform.

Out of these, diethyl ether, dipropyl ether, dibutyl ether, tetrahydrofuran, dimethyl formamide, acetonitrile, dimethyl sulfoxide, ethylene glycol monomethyl ether acetate, methylene chloride and chloroform are particularly preferred.

These solvents may be used alone or in admixture of two or more.

When the reaction between the tantalum alkoxide and at least one compound selected from carbamic acid, carboxylic acid and carboxylic anhydride is carried out in the presence of the above solvent, the amount of the solvent is preferably 1 to 100 mL, more preferably 5 to 50 mL, particularly preferably 5 to 30 mL based on 1 g of the tantalum alkoxide.

When the reaction between the tantalum alkoxide and at least one compound selected from carbamic acid, carboxylic acid and carboxylic anhydride is carried out in the presence of a solvent, part of the solvent may be substituted by a monoalcohol and/or a monophenol.

Examples of the monoalcohol include methanol, ethanol, propanol, isopropanol, butanol, tert-butanol, hexanol, cyclohexanol, octanol, ethylene glycol monomethyl ether, ethylene glycol monoethyl ether, ethylene glycol monoisopropyl ether, diethylene glycol monomethyl ether, diethylene glycol monoethyl ether, propylene glycol monomethyl ether, propylene glycol monoethyl ether, glycerol dimethyl ether and glycerol diethyl ether.

Examples of the monophenol include phenol, methyl phenol, dimethyl phenol, trimethyl phenol, ethyl phenol, diethyl phenol and triethyl phenol.

When the above reaction is carried out by substituting part of the solvent by a monoalcohol and/or a monophenol, the total amount of the monoalcohol and the monophenol is 20 wt % or less, more preferably 5 wt % or less based on the total amount of the solvents. When the total amount of the monoalcohol and/or the monophenol is larger than 20 wt %, the reaction between the tantalum alkoxide and at least one compound selected from carbamic acid, carboxylic acid and carboxylic anhydride may not proceed to the full.

The reaction product of the above reaction may be represented by the following formula (6), (7), (8) or (9): 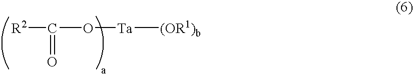
wherein R¹ is as defined in the above formula (1), R² is as defined in the above formula (2) or amino group, “a” is an integer of 1 to 5, and “b” is an integer of 0 to 4, with the proviso that a+b=5, 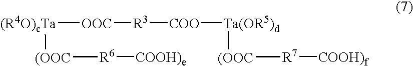
wherein R³, R⁶ and R⁷ are each independently a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms, R⁴ and R⁵ are each independently an alkyl group having 1 to 6 carbon atoms, “c” and “e” are each an integer of 0 to 4, with the proviso that c+e=4, and “d” and “f” are each an integer of 0 to 4, with the proviso that d+f=4,
(R⁹O)_{g}Ta(OOC—R⁸—COOH)ₕ (8)
wherein R⁸ is a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms, R⁹ is an alkyl group having 1 to 6 carbon atoms, “h” is an integer of 1 to 5, and “g” is an integer of 0 to 4, with the proviso that h+g=5, 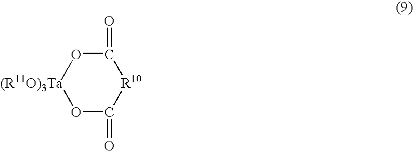
wherein R¹⁰ is a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms, and R¹¹ is an alkyl group having 1 to 6 carbon atoms.

In the above formula (6), R² is preferably an alkyl group having 1 to 6 carbon atoms or haloalkyl group having 1 to 6 carbon atoms, particularly preferably methyl group, trifluoromethyl group, trichloromethyl group or tribromomethyl group. R¹ is preferably an ethyl group, propyl group or butyl group. The value of “a” is preferably 1.

In the above formula (7), R³, R⁶ and R⁷ are each preferably an alkenylene group, that is, a divalent group having a carbon-carbon double bond formed by eliminating two hydrogen atoms from two carbon atoms adjacent to an alkylene group having 2 to 6 carbon atoms, particularly preferably —CH═C— or —C(CH₃)═CH—. R⁴ and R⁵ are each preferably an ethyl group, propyl group or butyl group. The values of “c” and “d” are preferably 4, and the values of “e” and “f” are preferably 0.

In the above formula (8), R⁹ is preferably an ethyl group, propyl group or butyl group, R⁸ is preferably an alkenylene group, that is, a divalent group having a carbon-carbon double bond formed by eliminating two hydrogen atoms from two carbon atoms adjacent to an alkylene group having 2 to 6 carbon atoms, particularly preferably —CH═CH— or —C(CH₃)═CH—. The value of “g” is preferably 4.

In the above formula (9), R¹⁰ is preferably an alkenylene group, that is, a divalent group having a carbon-carbon double bond formed by eliminating two hydrogen atoms from two carbon atoms adjacent to an alkylene group having 2 to 6 carbon atoms, particularly preferably —CH═CH— or —C(CH₃)═CH—. R¹¹ is preferably an ethyl group, propyl group or butyl group.

Whether the reaction product of the tantalum alkoxide and at least one compound selected from carbamic acid, carboxylic acid and carboxylic anhydride has one of the above structures depends on the type and amount based on the tantalum alkoxide of at least one compound selected from carbamic acid, carboxylic acid and carboxylic anhydride. For example, when carbamic acid or carboxylic acid having one carboxyl group in the molecule is used as the at least one compound selected from carbamic acid, carboxylic acid and carboxylic anhydride, it is considered that the reaction product has the structure of the above formula (6).

When a polycarboxylic acid having two or more carboxyl groups in the molecule or anhydride thereof is used, it is considered that the reaction product has at least one of the structures of the above formulas (7), (8) and (9).

For example, when maleic acid or citraconic acid is used as the at least one compound selected from carboxylic acid and carboxylic anhydride, the reaction product has mainly the structure of the above formula (7).

The composition for forming a coating film of the present invention may comprise one of the above reaction products or a mixture of two or more of the reaction products.

Solvent

The composition for forming a coating film of the present invention contains a reaction product of the above tantalum alkoxide and at least one compound selected from carbamic acid, carboxylic acid and carboxylic anhydride and a solvent as essential ingredients.

The solvent which can be used in the composition of the present invention is preferably a solvent which dissolves or disperses the above reaction product and optional additives as described hereinafter and does not react with these. The solvents which are enumerated above as able to be used in the reaction between the tantalum alkoxide and at least one compound selected from carbamic acid, carboxylic acid and carboxylic anhydride are preferably used as the solvent.

The alcohol-based solvent may react with the reaction product if an alkoxy group remains in the reaction product of the tantalum alkoxide and at least one compound selected from carbamic acid, carboxylic acid and carboxylic anhydride. However, this does not lessen the effect of the present invention. The alcohol-based solvent can be suitably used as the solvent of the composition of the present invention.

The alcohol-based solvents which are enumerated above as able to be used in the reaction between the tantalum alkoxide and at least one compound selected from carbamic acid, carboxylic acid and carboxylic anhydride may be preferably used as the alcohol-based solvent.

Out of these, monoalcohol-based solvents and ether-based solvents are preferred, propylene glycol monomethyl ether, propylene glycol monoethyl ether, propylene glycol monopropyl ether, bis (2-methoxyethyl)ether, diethylene glycol diethyl ether and diethylene glycol methyl ethyl ether are more preferred, and propylene glycol monomethyl ether, diethylene glycol diethyl ether and diethylene glycol methyl ethyl ether are particularly preferred.

These solvents may be used alone or in admixture of two or more.

When a solvent is used in the reaction between a tantalum alkoxide and at least one compound selected from carbamic acid, carboxylic acid and carboxylic anhydride, it may be used as the solvent of the composition of the present invention without removing it, or it may be removed after the reaction and a solvent may be newly added after the purification of the reaction product of a tantalum alkoxide and at least one compound selected from carbamic acid, carboxylic acid and carboxylic anhydride as required. A solvent may be further added to prepare the composition of the present invention without removing the solvent used in the reaction step.

Optional Additives

The composition for forming a coating film of the present invention comprises the above reaction product of a tantalum alkoxide and at least one compound selected from carbamic acid, carboxylic acid and carboxylic anhydride and a solvent as essential ingredients and may further contain optional additives in limits that do not lessen the effect of the present invention.

The optional additives include an orthocarboxylic ester, surfactant, metal oxide particle, etc.

Orthocarboxylic Ester

The orthocarboxylic ester may be added to further improve the water resistance of the composition of the present invention.

The orthocarboxylic ester which can be used in the present invention is, for example, an alkyl ester or aryl ester of an orthocarboxylic acid.

Specific examples of the alkyl ester of an orthocarboxylic acid include trimethyl orthoformate, triethyl orthoformate, tripropyl orthoformate, tributyl orthoformate, tripentyl orthoformate, diethylpropyl orthoformate, trimethyl orthoacetate, triethyl orthoacetate, tripropyl orthoacetate, tributyl orthoacetate, tripentyl orthoacetate, diethylpropyl orthoacetate, trimethyl orthopropionate, triethyl orthopropionate, tripropyl orthopropionate, tributyl orthopropionate, tripentyl orthopropionate, diethylpropyl orthopropionate, trimethyl orthobutyrate, triethyl orthobutyrate, tripropyl orthobutyrate, tributyl orthobutyrate, tripentyl orthobutyrate, diethylpropyl orthobutyrate, trimethyl ortholaurate, triethyl ortholaurate, tripropyl ortholaurate, tributyl ortholaurate, tripentyl ortholaurate, diethylpropyl ortholaurate, trimethyl orthobenzoate, triethyl orthobenzoate, tripropyl orthobenzoate, tributyl orthobenzoate, tripentyl orthobenzoate, diethylpropyl orthobenzoate, trimethyl ortholactate, triethyl ortholactate, tripropyl ortholactate, tributyl ortholactate, tripentyl ortholactate and diethylpropyl ortholactate.

Specific examples of the aryl ester of an orthocarboxylic acid include triphenyl orthoformate, triphenyl orthoacetate, triphenyl orthopropionate, triphenyl orthobutyrate, triphenyl ortholaurate, triphenyl orthobenzoate and triphenyl ortholactate.

Out of these orthocarboxylic esters, alkyl esters of an orthocarboxylic acid are preferred, and methyl esters and ethyl esters of an orthocarboxylic acid are more preferred from the viewpoint of the effect of improving water resistance. Trimethyl orthoformate, triethyl orthoformate and trimethyl orthobenzoate are particularly preferred.

These orthocarboxylic esters may be used alone or in admixture of two or more.

Surfactant

The surfactant may be added to improve the coatability of the composition of the present invention and the thickness uniformity of the formed tantalum oxide film,

The surfactant is a fluorine-based surfactant, silicone-based surfactant or nonionic surfactant.

Examples of the above fluorine-based surfactant include perfluoroalkyl carboxylates, perfluoroalkyl group-containing sulfuric ester salts, perfluoroalkyl group-containing sulfonates, perfluoroalkyl group-containing sulfosuccinates, perfluoroalkyl group-containing phosphoric ester salts, perfluoroalkyltrialkylammonium salts, perfluoroalkyl polyoxyethylene and perfluoroalkyl betain.

Examples of the above silicone-based surfactant include a copolymer of polyxoyethylene and methyl polysiloxane.

Examples of the above nonionic surfactant include polyoxyethylene alkyl ethers and polyoxyethylene alkyl phenyl ethers.

Metal Oxide Particle

The metal oxide particle may be added to obtain a fine tantalum oxide film.

Examples of the metal oxide particle include tantalum oxide, aluminum oxide, zirconium oxide, titanium oxide and silicon oxide.

The shape of the metal oxide fine particle may be a proper shape such as globular, polyhedral or cylindrical, preferably globular (not only spherical but also substantially globular).

The particle diameter of the metal oxide is preferably 1 to 100 nm, more preferably 1 to 10 nm.

Amount of Each Component

The composition for forming a coating film of the present invention contains the reaction product of a tantalum alkoxide and at least one compound selected from carbamic acid, carboxylic acid and carboxylic anhydride and a solvent as essential ingredients and optionally the above additives.

The amount of the reaction product of a tantalum alkoxide and at least one compound selected from carbamic acid, carboxylic acid and carboxylic anhydride contained in the composition for forming a coating film of the present invention may be a suitable value according to the thickness of the target tantalum oxide film or the like but preferably 0.1 to 50 wt %, more preferably 5 to 20 wt % based on the total weight of the composition.

When the composition for forming a coating film of the present invention contains an orthocarboxylic ester, the amount of the orthocarboxylic ester is preferably 20 wt % or less, more preferably 10 wt % or less based on the total weight of the composition.

When the composition for forming a coating film of the present invention contains a surfactant, the amount of the surfactant is preferably 5 wt % or less, more preferably 3 wt % or less based on the total weight of the composition.

When the composition for forming a coating film of the present invention contains a metal oxide particle, the amount of the metal oxide particle is preferably 30 wt % or less, more preferably 10 wt % or less based on the total weight of the composition.

The total amount of all the components excluding the solvent of the composition of the present invention is preferably 0.1 to 50 wt %, more preferably 5 to 20 wt % based on the total weight of the composition.

The composition of the present invention can be kept in an airtight container which can be generally acquired industrially at a high humidity for a long time as obvious from examples which will be described hereinafter. For example, when 10 mL of a conventionally known composition for forming a tantalum oxide film was put in a LABORAN (registered trademark) screw bottle No. 5 (capacity of 20 mL, manufactured by Azwan Co., Ltd.) and kept airtight at room temperature (23° C.) and a humidity of 3 g/m³, it could be kept for only one month. In contrast to this, a tantalum oxide film having desired properties could be obtained from the composition of the present invention even after it was kept for 3 months under the same conditions as above. At a humidity of 9 g/m³, the conventionally known composition for forming a tantalum oxide film could be kept for only 2 weeks. In contrast to this, a tantalum oxide film having desired properties could be obtained from the composition of the present invention after it was kept for 1 month under the same conditions as above.

The composition for forming a coating film of the present invention may be filtered with a filter having a pore diameter of 0.2 μm as required before use.

Method of Forming a Tantalum Oxide Film

A description is subsequently given of the method of forming a tantalum oxide film.

The method of forming a tantalum oxide film of the present invention comprises at least the following steps:

(1) forming a coating film of the above composition for forming a coating film on a substrate; and

(2) thermally and/or optically treating the coating film.

(1) Step of Forming a Coating Film of the Above Composition for Forming a Coating Film on a Substrate

The above composition is first applied to the substrate to form a coating film of the composition of the present invention. The material of the substrate is glass, metal, plastic or ceramic. Examples of the glass include quartz glass, borosilicate glass, soda glass and lead glass. Examples of the metal include gold, silver, copper, nickel, silicon, aluminum, iron and stainless steel. Examples of the plastic include polyimides, polyether sulfones, norbornene-based ring-open polymers and hydrogenated products thereof. When a thermal treatment is carried out in the subsequent step, a material which can stand that temperature must be used. The surface form of the substrate may be flat, non-flat with a level difference or curved. The 3-D form of the substrate is not particularly limited and may be block-like, plate-like, cylindrical or film-like.

The method of applying the composition is not particularly limited and may be a proper method such as spin coating, dip coating, flow coating, curtain coating, roll coating, spray coating, bar coating, ink jetting or printing. The composition may be applied once or a plurality of times. The preferred thickness of the coating film may be suitably set according to the thickness of a desired tantalum oxide film. Since the thickness of the coating film is generally reduced by the subsequent thermal and/or optical treatment(s), the thickness of the coating film must be set in consideration of it. For example, the thickness of the coating film of the composition is preferably set to 0.015 to 15 μm to obtain a tantalum oxide film having a thickness of 0.001 to 10 μm and to 0.008 to 1.5 μm to obtain a tantalum oxide film having a thickness of 0.005 to 1 μm. It should be understood that the thickness of the coating film of the composition is the thickness after the removal of the solvent.

The step of forming a coating film in the present invention can be carried out without being influenced by humidity (content of water vapor in the atmosphere). For example, even when a coating film is formed at an ambient humidity higher than 5 g/m³, a high-quality tantalum oxide film can be obtained and even when a coating film is formed at an ambient humidity of 11 g/m³ or more, particularly 15 g/m³ or more, a high-quality tantalum oxide film can be obtained. The conventionally known composition for forming a tantalum oxide film is strongly influenced by the ambient humidity in the step of forming a coating film. For example, when a coating film is formed at an ambient humidity of 9 g/m³ or more, the obtained tantalum oxide film tends to become unsatisfactory in terms of properties.

(2) Step of Thermally and/or Optically Treating the Coating Film

The coating film formed as described above can be changed into a tantalum oxide film by a thermal and/or optical treatment(s).

The above thermal treatment temperature is preferably 200° C. or higher, more preferably 30 to 900° C., much more preferably 350 to 800° C. The heating time may be suitably set according to the film thickness, etc. For example, to obtain a high-quality film, the coating film is preferably heated for 5 minutes or longer, more preferably 15 to 90 minutes, much more preferably 30 to 60 minutes.

A mixed gas of pure oxygen and other inert gas such as nitrogen, helium or argon, or air may be used as the atmosphere of the above thermal treatment step. Air suffices as the atmosphere of the thermal treatment step but the concentration of oxygen is preferably high. When the coating film is heated at an oxygen concentration of 10% or more, a high-quality tantalum oxide film can be stably obtained advantageously.

As the light source used for the above optical treatment may be used a low-pressure or high-pressure mercury lamp, deuterium lamp, rare gas discharge lamp such as argon, krypton or xenon discharge lamp, YAG laser, argon laser, carbonic acid gas laser, or excimer laser such as XeF, XeCl, XeBr, KrF, KrCl, ArF or ArCl laser. The wavelength of the light source is not particularly limited but preferably includes a wavelength of 170 nm to 600 nm. Particularly preferably, it includes a wavelength of 253 nm.

The amount of exposure is preferably 1,000 to 200,000 J/m², more preferably 5,000 to 100,000 J/m².

The atmosphere for the optical treatment may be the same as that for the above thermal treatment. The temperature of the optical treatment may be suitable. For example, the optical treatment may be carried out at room temperature or simultaneously with the above heating step as will be described hereinafter.

Only a specific portion of the coating film may be exposed to light through a suitable pattern mask.

Only one of the above thermal and optical treatments may be carried out but both of them are preferably carried out to obtain a higher quality tantalum oxide film. The treatments may be carried out in an arbitrary order or simultaneously.

The obtained tantalum oxide film may be made amorphous or crystalline according to the conditions of the thermal and/or optical treatment(s). For example, when the temperature of the thermal treatment is lower than 450° C., an amorphous tantalum oxide film is apt to be obtained and when the temperature is 450° C. or higher, a crystalline tantalum oxide film is apt to be obtained.

The formed tantalum oxide film may be subjected to an oxygen plasma or UV-ozone treatment as required.

Tantalum Oxide Film

The thus obtained tantalum oxide film has a thickness of preferably 0.001 to 10 μm, more preferably 0.005 to 1 μm.

The term “tantalum oxide” in this specification is a meaning including not only an oxide of tantalum as stoichiometry but also an oxide of tantalum as non-stoichiometry.

The tantalum oxide film of the present invention has a large dielectric constant and a small leak current as obvious from examples which will be described hereinafter. The tantalum oxide film can be advantageously used as an insulating film for semiconductor devices such as a capacitor insulating film or gate insulating film for DRAMs and also as an anti-reflection film, passivation film or barrier film.

To use the tantalum oxide film as an insulating film for semiconductor devices, the tantalum oxide film must have a leak current of 10⁻⁶ A/cm² or less at a field strength of 1.5 V/cm and a dielectric constant of 18 or more. The tantalum oxide film of the present invention satisfies the above requirements.

### EXAMPLES

The following examples are provided for the purpose of further illustrating the present invention but are in no way to be taken as limiting. In the following examples and comparative example, “room temperature” means 23° C.

### Synthesis Example 1

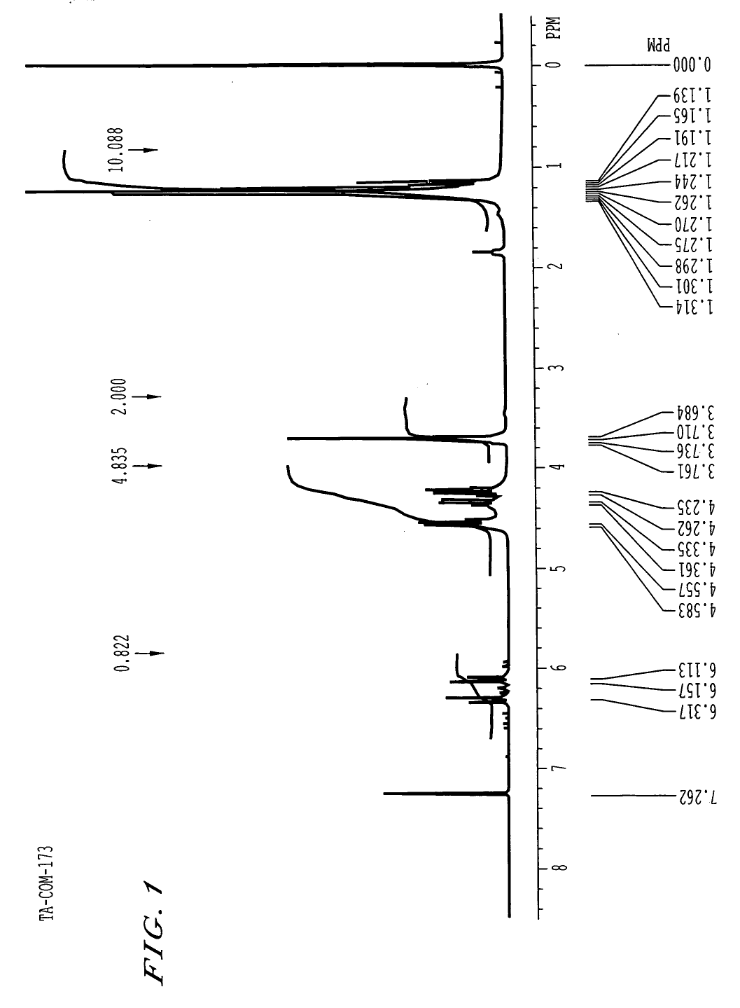

10 g (25 mmol) of tantalum pentaethoxide and 10 mL of tetrahydrofuran (THF) were injected into a 500 mL eggplant-like flask whose inside had been fully substituted by nitrogen under a nitrogen atmosphere, 2.4 g (25 mmol) of maleic anhydride was dissolved in 40 ml of tetrahydrofuran under agitation at room temperature, and the resulting solution was added dropwise to the above mixture at room temperature over 1 hour. Thereafter, the mixture was further stirred at room temperature for 5 hours. The reaction solution was slightly increased in viscosity while it was achromatic and transparent. When part of the reaction mixture was collected and analyzed by ¹H-NMR, it was assumed that the reaction mixture was a compound represented by the following formula (10). FIG. 1 shows a ¹H-NMR chart of the product.
(C₂H₅O)₄Ta(OCOCH═CHCOO)Ta(OC₂H₅)₄ (10)

Thereafter, propylene glycol monomethyl ether was added and tetrahydrofuran was removed under reduced pressure to prepare a solution. When part of the prepared solution was collected and heated in the air at 200° C. for 60 minutes, the mass of the residual solid was 10% of the mass before heating.

### Synthesis Example 2

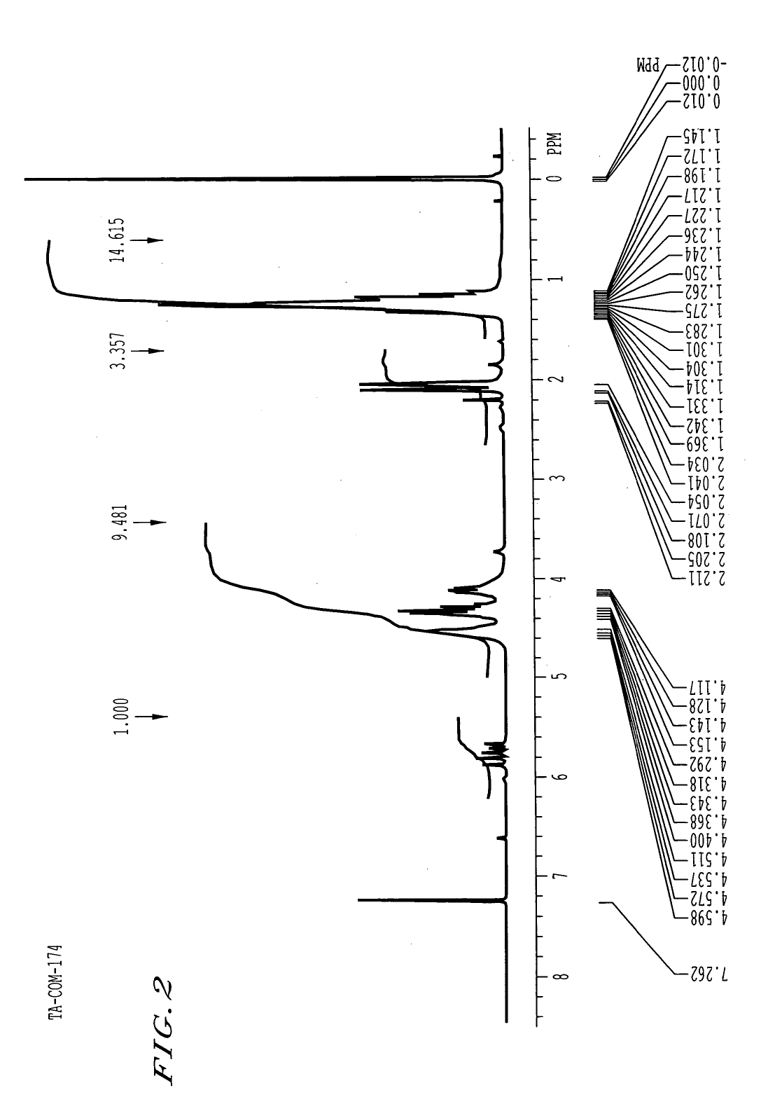

10 g (25 mmol) of tantalum pentaethoxide and 60 mL of propylene glycol monomethyl ether were injected into a 500 mL eggplant-like flask whose inside had been fully substituted by nitrogen under a nitrogen atmosphere, 2.7 g (25 mmol) of citraconic anhydride was dissolved in 40 ml of propylene glycol monomethyl ether under agitation at room temperature, and the resulting solution was added dropwise to the above mixture at room temperature over 1 hour. Thereafter, the mixture was further stirred at room temperature for 5 hours, whereby the reaction solution was slightly increased in viscosity while it was achromatic and transparent. Part of the reaction mixture solution was collected and analyzed by ¹H-NMR. FIG. 2 shows a ¹H-NMR chart of this product.

When part of the prepared reaction mixture solution was collected and heated in the air at 200° C. for 60 minutes, the mass of the residual solid was 10% of the mass before heating.

### Synthesis Example 3

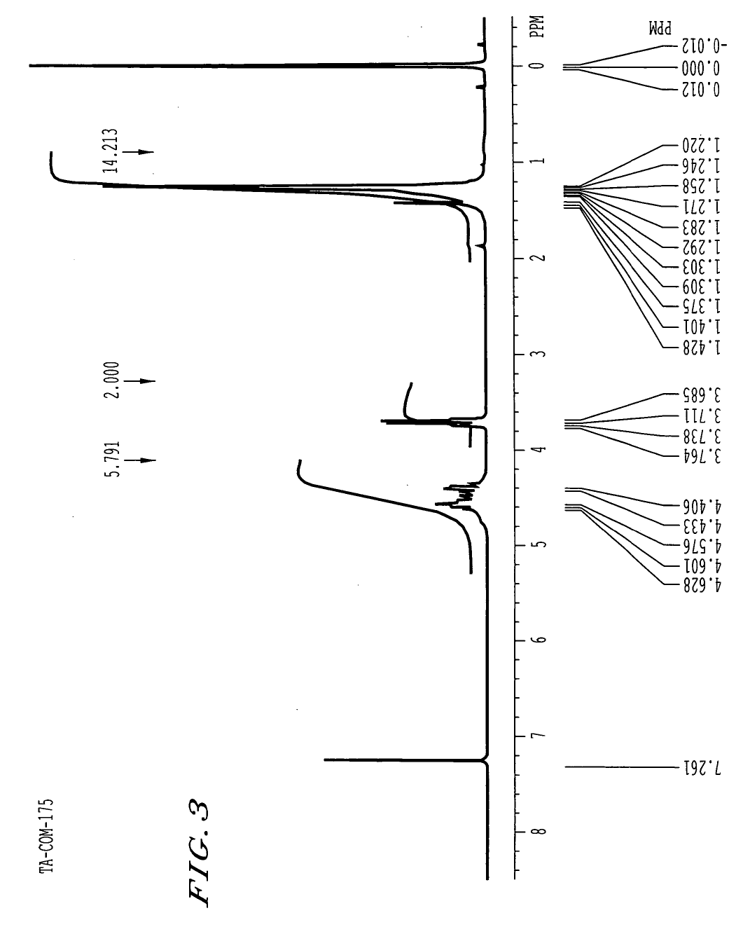

10 g (25 mmol) of tantalum pentaethoxide and 60 mL of propylene glycol monomethyl ether were injected into a 500 mL eggplant-like flask whose inside had been fully substituted by nitrogen under a nitrogen atmosphere, 2.8 g (25 mmol) of trifluoroacetic acid was dissolved in 40 ml of propylene glycol monomethyl ether under agitation at room temperature, and the resulting solution was added dropwise to the above mixture at room temperature over 1 hour. Thereafter, the mixture was further stirred at room temperature for 5 hours, whereby the reaction solution was slightly increased in viscosity while it was achromatic and transparent. Part of the reaction mixture solution was collected and analyzed by ¹H-NMR. FIG. 3 shows a ¹H-NMR chart of this product.

When part of the prepared reaction mixture solution was collected and heated in the air at 200° C. for 60 minutes, the mass of the residual solid was 10% of the mass before heating.

### Synthesis Example 4

10 g (25 mmol) of tantalum pentaethoxide and 60 mL of tetrahydrofuran (THF) were injected into a 500 mL eggplant-like flask whose inside had been fully substituted by nitrogen under a nitrogen atmosphere, 2.9 g (25 mmol) of maleic acid was dissolved in 40 ml of tetrahydrofuran under agitation at room temperature, and the resulting solution was added dropwise to the above mixture at room temperature over 1 hour. Thereafter, the mixture was further stirred at room temperature for 5 hours. The reaction solution was slightly increased in viscosity while it was achromatic and transparent.

Propylene glycol monomethyl ether was added to remove tetrahydrofuran under reduced pressure to prepare a solution.

When part of the prepared solution was collected and heated in the air at 200° C. for 60 minutes, the mass of the residual solid was 10% of the mass before heating.

Formation of Tantalum Oxide Film

### Example 1

The solution obtained in Synthesis Example 1 was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 30 nm and heated at 145° C. for 3 minutes to remove the solvent. The film thickness after the removal of the solvent was 18 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 15 nm. By repeating this operation, an achromatic and transparent film having a thickness of 30 nm was obtained. When the ESCA spectrum of this film was measured, it was found that this film was a tantalum oxide film. The obtained film had a leak current of 10⁻⁹ A/cm² at a field strength of 1.5 MV/cm and a dielectric constant of 24.8.

### Example 2

The solution obtained in Synthesis Example 2 was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 32 nm and heated at 145° C. for 3 minutes to remove the solvent. The film thickness after the removal of the solvent was 19 nm.

When the film was exposed to 50,000 J/m² of light having a wavelength of 253 nm in an oxygen atmosphere and heated in the air at 400° C. for 30 minutes, a transparent film was formed on the substrate. This film had a thickness of 17 nm. By repeating this operation, an achromatic and transparent film having a thickness of 35 nm was obtained. When the ESCA spectrum of this film was measured, it was found that this film was a tantalum oxide film. The obtained film had a leak current of 10⁻⁹ A/cm² at a field strength of 1.5 MV/cm and a dielectric constant of 25.9.

### Example 3

The reaction mixture solution obtained in Synthesis Example 3 was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 35 nm and heated at 145° C. for 3 minutes to remove the solvent. The film thickness after the removal of the solvent was 22 nm.

When the film was exposed to 30,000 J/m² of light having a wavelength of 253 nm in an oxygen atmosphere and heated in the air at 370° C. for 30 minutes, a transparent film was formed on the substrate. This film had a thickness of 18 nm. By repeating this operation, an achromatic and transparent film having a thickness of 37 nm was obtained. When the ESCA spectrum of this film was measured, it was found that this film was a tantalum oxide film. The obtained film had a leak current of 10⁻⁸ A/cm² at a field strength of 1.5 MV/cm and a dielectric constant of 25.1.

### Example 4

10 mL of the solution obtained in Synthesis Example 4 was kept airtight in a LABORAN (registered trademark) screw bottle No. 5 (capacity of 20 mL, manufactured by Azwan Co., Ltd.) at room temperature and an ambient humidity of 9 g/m³ for one month. This solution was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 35 nm and heated at 145° C. for 3 minutes to remove the solvent. The film thickness after the removal of the solvent was 22 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 20 nm. By repeating this operation, an achromatic and transparent film having a thickness of 42 nm was obtained. When the ESCA spectrum of this film was measured, it was found that this film was a tantalum oxide film. The obtained film had a leak current of 10⁻⁸ A/cm² at a field strength of 1.5 MV/cm and a dielectric constant of 24.5.

A conventionally known composition for forming a tantalum oxide film could be kept at a high humidity of 9 g/m³ under the same airtight condition as above for up to 2 weeks. Meanwhile, it was confirmed that after the composition for forming a tantalum oxide film of the present invention was kept for one month, a high-quality tantalum oxide film could be formed from the composition.

### Example 5

10 mL of the solution obtained in Synthesis Example 4 was kept airtight in a LABORAN (registered trademark) screw bottle No. 5 (capacity of 20 mL, manufactured by Azwan Co., Ltd.) at room temperature and an ambient humidity of 3 g/m³ for 3 months. This solution was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 33 nm and heated at 145° C. for 3 minutes to remove the solvent. The film thickness after the removal of the solvent was 22 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 20 nm. By repeating this operation, an achromatic and transparent film having a thickness of 40 nm was obtained. When the ESCA spectrum of this film was measured, it was found that this film was a tantalum oxide film.

The obtained film had a leak current of 10⁻⁸ A/cm² at a field strength of 1.5 MV/cm and a dielectric constant of 25.2.

A conventionally known composition for forming a tantalum oxide film could be kept at a humidity of 3 g/m³ under the same airtight condition as above for up to 1 month. Meanwhile, it was confirmed that after the composition for forming a tantalum oxide film of the present invention was kept for 3 months, a high-quality tantalum oxide film could be formed from the composition.

### Example 6

The solution obtained in Synthesis Example 1 was left in the air and kept at room temperature and an ambient humidity of 9 g/m³ for 24 hours. This solution was filtered with a Teflon (registered trademark) filter having a pore diameter of 0.2 μm to prepare a composition for forming a coating film.

This composition was applied to a silicon substrate having a 200 nm-thick platinum coating film at an ambient humidity of 15 g/m³ by spin coating at 2,000 rpm to a film thickness of 33 nm and heated at 145° C. for 3 minutes to remove the solvent. The film thickness after the removal of the solvent was 23 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 21 nm. By repeating this operation, an achromatic and transparent film having a thickness of 43 nm was obtained. When the ESCA spectrum of this film was measured, it was found that this film was a tantalum oxide film. The obtained film had a leak current of 10⁻⁸ A/cm² at a field strength of 1.5 MV/cm and a dielectric constant of 24.9.

It was confirmed that a solution of the composition for forming a coating film of the present invention could be used after it was left in the air and kept at an ambient humidity of 9 g/m³ for 24 hours.

### Example 7

The solution obtained in Synthesis Example 1 was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 13 g/m³ by spin coating at 2,000 rpm to a film thickness of 33 nm and heated at 145° C. for 3 minutes to remove the solvent. The film thickness after the removal of the solvent was 19 nm.

When the film was head in the air at 370° C. for 30 minutes, a transparent film was formed on the substrate. This film had a thickness of 17 nm. By repeating this operation twice, a film having a total thickness of 35 nm was obtained. When the ESCA spectrum of this film was measured, it was found that this film was a tantalum oxide film. The obtained film had a leak current of 10⁻⁶ A/cm² at a field strength of 1.5 MV/cm and a dielectric constant of 19.2.

### Example 8

1 g of ethyl orthoacetate was added to 10 g of the reaction mixture solution obtained in Synthesis Example 2, and the resulting mixture was filtered with a Teflon (registered trademark) filter having a pore diameter of 0.2 μm to prepare a composition for forming a tantalum oxide film.

This composition was applied to a silicon substrate having a 200 nm-thick platinum coating film at an ambient humidity of 15 g/m³ by spin coating at 2,000 rpm to a film thickness of 31 nm and heated at 145° C. for 3 minutes to remove the solvent. The film thickness after the removal of the solvent was 20 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 16 nm. By repeating this operation twice, an achromatic and transparent film having a thickness of 32 nm was obtained. When the ESCA spectrum of this film was measured, it was found that this film was a tantalum oxide film.

The obtained film had a leak current of 10⁻⁹ A/cm² at a field strength of 1.5 MV/cm and a dielectric constant of 22.8.

### Referential Example 1

10 mL of a solution prepared by dissolving 10 parts by weight of tantalum pentaethoxide in 90 parts by weight of propylene glycol monomethyl ether was kept airtight in a LABORAN (registered trademark) screw bottle No. 5 (capacity of 20 mL, manufactured by Azwan Co., Ltd.) at room temperature and an ambient humidity of 9 g/m³ for 2 weeks. The obtained solution was filtered with a Teflon (registered trademark) filter having a pore diameter of 0.2 μm.

This filtrate was applied to a silicon substrate having a 200 nm-thick platinum coating film at an ambient humidity of 15 g/m³ by spin coating at 2,000 rpm to a film thickness of 35 nm and heated at 145° C. for 3 minutes to remove the solvent. The film thickness after the removal of the solvent was 24 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 21 nm. By repeating this operation twice, an achromatic and transparent film having a thickness of 43 nm was obtained. When the ESCA spectrum of this film was measured, it was found that this film was a tantalum oxide film. The obtained film had a leak current of 10⁻⁷ A/cm² at a field strength of 1.5 MV/cm and a dielectric constant of 18.3.

### Comparative Example 1

The solution used in Referential Example 1 was further kept under the same airtight condition for another 2 weeks (4 weeks in total, kept airtight at room temperature and an ambient humidity of 9 g/m³). The obtained solution was filtered with a Teflon (registered trademark) filter having a pore diameter of 0.2 μm.

This filtrate was applied to a silicon substrate having a 200 nm-thick platinum coating film at an ambient humidity of 15 g/m³ by spin coating at 2,000 rpm to a thickness of 33 nm and heated at 145° C. for 3 minutes to remove the solvent. The thickness of the film after the removal of the solvent was 24 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 20 nm. By repeating this operation twice, an achromatic and transparent film having a thickness of 40 nm was obtained. When the ESCA spectrum of this film was measured, it was found that this film was a tantalum oxide film. The obtained film had a leak current of 10⁻² A/cm² at a field strength of 1.5 MV/cm and a dielectric constant of 10.1.

### Referential Example 2

10 mL of a solution prepared by dissolving 10 parts by weight of tantalum pentaethoxide in 90 parts by weight of propylene glycol monomethyl ether was kept airtight in a LABORAN (registered trademark) screw bottle No. 5 (capacity of 20 mL, manufactured by Azwane Co., Ltd.) at room temperature and an ambient humidity of 3 g/m³ for one month. The obtained solution was filtered with a Teflon (registered trademark) filter having a pore diameter of 0.2 μm.

This filtrate was applied to a silicon substrate having a 200 nm-thick platinum coating film at an ambient humidity of 15 g/m³ by spin coating at 2,000 rpm to a film thickness of 33 nm and heated at 145° C. for 3 minutes to remove the solvent. The film thickness after the removal of the solvent was 24 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 21 nm. By repeating this operation twice, an achromatic and transparent film having a thickness of 42 nm was obtained. When the ESCA spectrum of this film was measured, it was found that this film was a tantalum oxide film. The obtained film had a leak current of 10⁻⁷ A/cm² at a field strength of 1.5 MV/cm and a dielectric constant of 22.5.

### Comparative Example 2

The solution used in Referential Example 2 was further kept under the same airtight condition for another 2 months (3 months in total, kept airtight at room temperature and an ambient humidity of 3 g/m³). The obtained solution was filtered with a Teflon (registered trademark) filter having a pore diameter of 0.2 μm.

This filtrate was applied to a silicon substrate having a 200 nm-thick platinum coating film at an ambient humidity of 15 g/m³ by spin coating at 2,000 rpm to a thickness of 34 nm and heated at 145° C. for 3 minutes to remove the solvent. The thickness of the film after the removal of the solvent was 25 nm.

When the film was exposed to 50,000 J/m² of light having a wavelength of 253 nm in an oxygen atmosphere and heated in the air at 370° C. for 30 minutes, a transparent film was formed on the substrate. This film had a thickness of 21 nm. By repeating this operation twice, an achromatic and transparent film having a thickness of 41 nm was obtained. When the ESCA spectrum of this film was measured, it was found that this film was a tantalum oxide film. The obtained film had a leak current of 10⁻² A/cm² at a field strength of 1.5 MV/cm and a dielectric constant of 9.68.

### Comparative Example 3

A solution prepared by dissolving 10 parts by weight of tantalum pentaethoxide in 90 parts by weight of propylene glycol monomethyl ether was left in the air and kept at an ambient humidity of 9 g/m³ for 24 hours. Since a precipitate was formed from the solution and partly solidified, it could not be applied.

As described above, according to the present invention, there are provided a composition for forming a coating film, from which a high-quality tantalum oxide film having a sufficiently large dielectric constant and a small leak current can be formed easily and efficiently and which can be kept at a high ambient humidity for a long time, a method capable of forming a high-quality tantalum oxide film from the composition even at a high humidity, and a high-quality tantalum oxide film formed from the composition.

1. A composition for forming a coating film, which comprises a reaction product of a tantalum alkoxide and at least one compound selected from the group consisting of carbamic acid, carboxylic acid and carboxylic anhydride and a solvent and which is used to form a tantalum oxide film.

2. The composition for forming a coating film of claim 1, wherein the tantalum alkoxide is represented by the following formula (1):
Ta(OR¹)₅ (1)
wherein R¹ is an alkyl group having 1 to 6 carbon atoms, with the proviso that five R¹'s may be the same or different.

3. The composition for forming a coating film of claim 1, wherein the carboxylic acid is represented by the following formula (2): 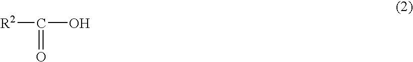
wherein R² is an alkyl group having 1 to 6 carbon atoms or haloalkyl group having 1 to 6 carbon atoms, or the following formula (3):
HOOC—R³—COOH (3)
wherein R³ is a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms.

4. The composition for forming a coating film of claim 1, wherein the carboxylic anhydride is represented by the following formula (4): 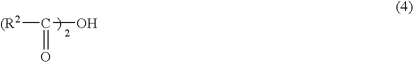
wherein R² is as defined in the above formula (2), or the following formula (5): 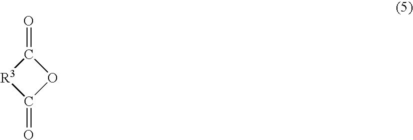
wherein R³ is as defined in the above formula (3).

5. The composition for forming a coating film of claim 3, wherein the carboxylic acid is maleic acid or citraconic acid.

6. The composition for forming a coating film of claim 4, wherein the carboxylic anhydride is maleic anhydride or citraconic anhydride.

7. The composition for forming a coating film of claim 1, wherein the reaction product is at least one selected from the group consisting of a compound represented by the following formula (6): 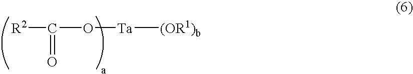
wherein R¹ is as defined in the above formula (1), R² is as defined in the above formula (2) or amino group, “a” is an integer of 1 to 5, and “b” is an integer of 0 to 4, with the proviso that a+b=5,
and a compound represented by the following formula (7): 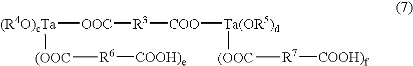
wherein R³, R⁶ and R⁷ are each independently a single bond, methylene group, halomethylene group, alkylene group having 2 to 6 carbon atoms, haloalkylene group having 2 to 6 carbon atoms, alkenylene group having 2 to 6 carbon atoms or haloalkenylene group having 2 to 6 carbon atoms, R⁴ and R⁵ are each independently an alkyl group having 1 to 6 carbon atoms, “c” and “e” are each an integer of 0 to 4, with the proviso that c+e=4, and “d” and “f” are each an integer of 0 to 4, with the proviso that d+f=4.

8. A method of preparing the composition for forming a coating film of claim 1, comprising the steps of:
(1) reacting a tantalum alkoxide with at least one compound selected from the group consisting of carbamic acid, carboxylic acid and carboxylic anhydride in the presence of a solvent as required; and
(2) adding a solvent to the obtained reaction product as required so as to prepare a composition for forming a coating film, containing the solvent.

9. A method of forming a tantalum oxide film, comprising the steps of:
(1) forming a coating film of the composition for forming a coating film of claim 1 on a substrate; and
(2) thermally and/or optically treating the coating film.

10. A tantalum oxide film formed from the composition for forming a coating film of claim 1.

11. A tantalum oxide film formed by the method of claim 9.
